(19) United States
(12) Patent Application Publication
(10) Pub. No.: US 2025/0385247 A1
(43) Pub. Date: Dec. 18, 2025

(54) ELECTRODE FOR A SECONDARY CELL

(71) Applicant: NORTHVOLT AB, Stockholm (SE)

(72) Inventors: Prasad Mangesh KORDE, Västerås (SE); Young Hun LEE, Stockholm (SE); Heesu OH, Västerås (SE); Marouene Ben MESSAOUD, Hägersten (SE)

(21) Appl. No.: 18/878,807

(22) PCT Filed: Jul. 4, 2023
(86) PCT No.: PCT/EP2023/068343

§ 371 Date: Dec. 24, 2024

(30) Foreign Application Priority Data
Jul. 4, 2022 (SE) 2250839-4

(51) Int. Cl. H01M 4/1393; H01M 4/02; H01M 4/04; H01M 4/133

(52) U.S. Cl. CPC H01M 4/1393; H01M 4/0404; H01M 4/0435; H01M 4/133; H01M 2004/021

(57) ABSTRACT

A method for manufacturing an electrode for a secondary cell, comprising the steps of: providing an electrode substrate comprising an electrically conducting material; forming an active layer on the electrode substrate, wherein the active layer comprises a plurality of carbonaccous particles; exposing the active layer to a magnetic field configured to orient a majority of the particles along a normal of the substrate; and exposing the active layer to laser pulses or mechanical rollers to form a plurality of passages in the active layer, thereby facilitating ionic transport towards the substrate.

### TECHNICAL FIELD

The present disclosure generally relates to electrodes for a secondary cell, methods for manufacturing such electrodes, and secondary cells comprising such electrodes.

### BACKGROUND

Rechargeable or secondary batteries (cells) find widespread use as electrical power supplies and energy storage systems. For example, in automobiles, battery packs formed of a plurality of lithium-ion battery cells are provided as a means of effective storage and utilization of electric power. The lithium-ion battery cells represent a type of rechargeable batteries in which lithium ions move from the negative electrode through an electrolyte to the positive electrode during discharge and in a reverse direction during charge.

Electrodes in rechargeable batteries comprise active materials participating in the electrochemical charge and discharge reactions. Commonly, graphite is used as active material in anodes thanks to its abundance and relatively low cost.

However, there is an ever-increasing demand in the industry for improved anodes providing, for instance, increased charging density and reduced charging time.

### SUMMARY

The present disclosure aims at providing improved electrodes and manufacturing methods thereof, as defined in the independent claims.

Hence, according to a first aspect, a method for manufacturing an electrode for a secondary cell is provided, comprising the steps of:
providing an electrode substrate comprising an electrically conducting material;
forming an active layer on the electrode substrate, wherein the active layer comprises a plurality of carbonaceous particles;
exposing the active layer to a magnetic field configured to orient a majority of the particles substantially parallel to a normal of the substrate; and
exposing the active layer to laser pulses or a mechanical roller to form a plurality of passages in the active layer, thereby facilitating ionic transport towards the substrate.

According to a second aspect, an electrode for a secondary cell is provided, comprising:
an electrode substrate comprising an electrically conducting material; and
an active layer arranged on the substrate;
wherein the active layer comprises a plurality of passages extending in a direction parallel to a normal of the substrate to facilitate ionic transport towards the substrate; and
wherein the active layer comprises a plurality of carbonaceous particles, of which a majority are oriented substantially parallel to the normal of the substrate.

The morphology of the active layer has turned out to be an important factor affecting the electrochemical performance of the electrode. The inventors have realized that by orienting the particles along the normal of the substrate, such that a majority of the particles have a similar orientation with respect to each other, a beneficial effect is observed on the ion diffusion coefficient, i.e., the speed with which the ions in the electrolyte can move into and out from the active layer. Put differently, by increasing the ordering of the particles the tortuosity and ionic resistance of the material is reduced. As a result, the charging and discharging speed is improved. Further, the improved ordering of the particles increases the intercalation efficiency and allow the particles to be more densely packed, resulting in an electrode having increased energy density.

A magnetic field is used to orient the particles along the normal of the substrate. The magnetic field may hence be applied to the active layer to induce a dipole moment causing the particles to rotate and align with the field lines of the magnetic field. It is realized that this effect may be employed both for elongated particles having a main direction of extension, and planar or flake-shaped particles extending in a main plane of extension. By applying a magnetic field, the particles are forced to rotate such that their main direction of extension, or main plane of extension, aligns with the magnetic field lines.

The ionic transport towards the substrate is further facilitated by providing a plurality of passages in the active layer to increase the porosity and to further reduce the tortuosity of the active layer. The passages may be formed by means of a laser processing, in which the active layer is exposed to laser pulses. Alternatively, the passages may be formed by means of mechanical rolling, in which the active layer is at least partly penetrated using mechanical rollers comprising protrusions. The passages assist in reducing an ionic resistance of the active layer to enable an electrode having improved electrochemical performance. Beneficially, the passages also assist in facilitating electrolyte soaking of the active material to improve the mass and charge transport characteristics of the electrode. In some embodiments, the plurality of passages forms grooves or channels, such as zig-zag grooves, in the active layer.

Passages formed by laser processing may for example be identified through Laser Microscopy. Heat damage and traces of vaporization of active material can be observed on the edges of the passages. A heat-affected zone (HAZ) may be visible as a result of local heating induced by the laser processing. It is understood that the size of the HAZ increases with increased laser duration. The depth of the passages can be controlled by controlling the working distance of the laser source to the substrate and by adjusting different laser parameters such as laser power, laser frequency and laser pulse duration. Typically, the laser pulse duration is in the range of from 150 femtoseconds to 100 nanoseconds. The passages may penetrate several particles.

Passages formed by mechanical rolling may for example be identified through Laser Microscopy or Scanning Electron Microscopy. Said passages may for example penetrate several particles. The depth of the passages can be controlled by selecting a certain roll, e.g., a roll comprising certain protrusions or knurls arranged thereon. It is understood that during mechanical rolling the protrusions and/or knurls of the roll penetrate the layer such that passages are formed.

The term “a majority of the particles” refers to at least 50%, such as at least 60%, such as at least 70%, such as at least 80%, such as at least 90% of the particles of the active layer being oriented substantially parallel to a normal of the substrate.

Further, in the context of the present disclosure the term “along a normal”, or, put differently, “substantially parallel to the normal” refers to an orientation deviating 45° or less from the normal of the substrate. Particles oriented at angles exceeding 45° from the normal may instead be referred to as being parallel to the substrate. Hence, a particle may be considered to be oriented along the normal of the substrate, or, in different words, substantially parallel to the to the normal of the substrate, in case its length direction or main plane of extension deviates from the normal by less than 45°, such as 0° to 35°, such as 0° to 25°.

By the “normal of the substrate” or “normal direction” is understood the orthogonal direction to a main plane of extension of the substrate. Alternatively, the normal may correspond to a stacking direction of the layers forming the secondary cell.

The terms “elongated” and “length direction” may be understood by observing a particle extending in at least two different directions, of which the extension in a first direction is greater than an extension in a second direction. The extension in the first direction may then be referred to as the length direction. The particles may conform to three-dimensional shapes such as, for instance, ellipsoids and rods. Substantially planar particles, such as graphite flakes, may be characterized by their main plane of extension, which may be oriented such that the main plane of extension is substantially parallel to the normal of the substrate. Advantageously, such planar particles may be oriented parallel to each other as well to further increase the ordering of the particles.

The term “carbonaceous” is to be understood as describing a substance or material rich in carbon, such as containing or comprising a relatively high degree of carbon. Thus, a carbonaceous particle according to the present disclosure may, e.g., comprise or consist of graphite.

By “electrochemically active layer” is to be understood a layer comprising electrochemical species which can be oxidized and reduced in a system which enables a cell to produce electric energy during discharge. The electrochemically active layer, also referred to as “active layer”, may preferably be provided as a coating directly on the electrode substrate. The active layer may form a continuous layer covering at least a major part of the surface of the substrate.

Herein, the term “ionic transport” is to be understood as the movement or transfer of ions, e.g., during the charge or discharge of a secondary cell.

The carbonaceous particles may be ferromagnetic, paramagnetic or diamagnetic depending on the materials of which the particles are formed. In some embodiments, a dopant may be added to improve the magnetic properties. Preferably, the dopants may be provided to increase the magnetic dipole moment of the particles. Depending on the type of dopant, diamagnetic particles may be modified into being paramagnetic or ferromagnetic so as to exhibit a stronger interaction with an applied magnetic field.

In an example, the particles may be doped with paramagnetic nanoparticles, such as nanoparticles comprising Fe₃O₄, to provide paramagnetic properties. Such nanoparticles may be attached to the surface of the carbonateous particles by means of van Der Waals forces. In further examples, the particles may be doped with ferromagnetic particles to provide ferromagnetic properties.

In some embodiments, the electrode has an electrode density of from 1.4 to 1.7 g/cm³. Herein, the term “electrode density” is to be understood as the volumetric mass density of the active layer and, when present, the coating layer.

In some embodiments, the active layer may comprise a coating, or coating layer, formed on top of the active layer. With this arrangement, the plurality of carbonaceous particles may be arranged between the electrode substrate and the coating layer, which hence may function as a protective layer reducing the risk of the particles being misaligned during subsequent processing steps, such as e.g. calendering. The coating layer may hence provide mechanical protection increasing the robustness and stability of the active layer.

In some embodiments, the coating layer may comprise a plurality of coating layer particles, such as for example graphite particles or graphite flakes. Similar to the particles of the active layer mentioned above, the coating layer particles may be oriented along the normal of the substrate surface to facilitate ion transport through the coating layer. At least a majority, and preferably more, of the particles may be given this orientation by applying an external magnetic field similar to what is described above with reference to the ordering of the particles of the active layer.

In further embodiments, the coating layer may comprise particles comprising other materials than graphite. Examples of such materials may include Si-based materials selected from the group of metallic Si, Si alloys, and SiOx where x is less than or equal to 2. The coating layer may hence comprise particles or various materials, such as a combination of carbonaceous particles and Si-based particles.

In some embodiments, the plurality of passages may extend at least halfway through the active layer. Put differently, the plurality of passages may have a length corresponding to more than 0% and up to 95%, such as from 5% to 95%, such as from 25% to 90%, such as from 50% to 90% of the thickness of the active layer. In some embodiments, the passages do not extend to the substrate. Further, the passages may have a diameter of less than 60 μm, such as from 5 to 60 μm, such as from 10 to 50 μm, such as from 10 to 40 μm, such as from 12 to 35 μm, such as from 15 to 35 μm, such as from 15 to 30 μm.

In some embodiments, a calendering process, also referred to as a compaction process, may be performed to increase the coating density of the electrode. The compaction process may preferably involve pressing or rolling of the surface of the active layer and may be performed after the active layer has been exposed to the magnetic field and, in some examples prior to the laser treatment. In further examples, the calendering process may be performed after exposing the active layer to the laser pulses. It will be appreciated that the calendering process may be performed a single time or multiple times during the processing of the electrode.

According to a third aspect, there is provided a secondary cell comprising an electrode as described with reference to the second aspect. The above-mentioned features of the method according to the first aspect and the electrode according to the second aspect, when applicable, apply to this third aspect as well. In order to avoid undue repetition, reference is made to the above.

A further scope of applicability of the present inventive concept will become apparent from the detailed description given below. However, it should be understood that the detailed description and specific examples, while indicating preferred embodiments, are given by way of illustration only, since various changes and modifications within the scope of the appended claims will become apparent to those skilled in the art from this detailed description.

### BRIEF DESCRIPTION OF THE DRAWINGS

The above and other aspects of the present inventive concept will now be described in more detail with reference to the appended figures. The figures should not be considered limiting but are instead used for explaining and understanding. Like reference numerals refer to like elements throughout.

FIG. 1 is a cross-section of a substrate comprising an active layer.

FIG. 2a is a cross-section illustrating the application of a magnetic field to increase the ordering of the particles of the active layer.

FIG. 2b illustrates the orientation of a particle in relation to a normal of the substrate.

FIG. 3 is a cross-section of an electrode comprising an active layer and a coating layer.

FIG. 4 is a cross-section of the electrode of FIG. 2a, illustrating passages extending towards the surface of the substrate.

FIG. 5 is a cross-section of the electrode of FIG. 3, illustrating passages extending towards the surface of the substrate.

### DETAILED DESCRIPTION

A method for manufacturing an electrode for a secondary cell as well as the electrode as such will now be described with reference to the appended figures, illustrating cross sections of electrodes according some embodiments.

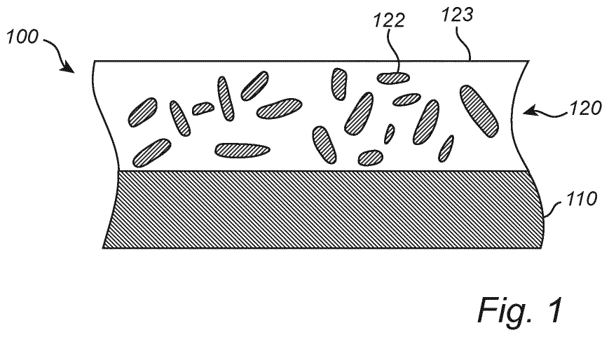

FIG. 1 illustrates an electrode substrate 110 formed of an electrically conducting material such as, for instance, a copper or aluminum foil. The substrate 110 may be at least partly coated with an active layer 120 configured to intercalate lithium ions to store electrical charge during charging of the battery cell. The electrode substrate 110 and the active layer 120 may thus form the anode of the resulting secondary cell.

The active layer 120 shown in FIG. 1 comprises a plurality of carbonaceous particles, such as graphite particles, suspended in a binder 123 comprising e.g. styrene butadiene copolymer (SBR), carboxymethyl cellulose (CMC), polyacrylates or polyvinylidene fluoride (PVDF). The active layer 120 may be provided as a slurry, in which the carbonaceous particles are dispersed in a fluid binder 123. The slurry may be coated on the electrode substrate 120, dried and calendered to form the resulting anode 100.

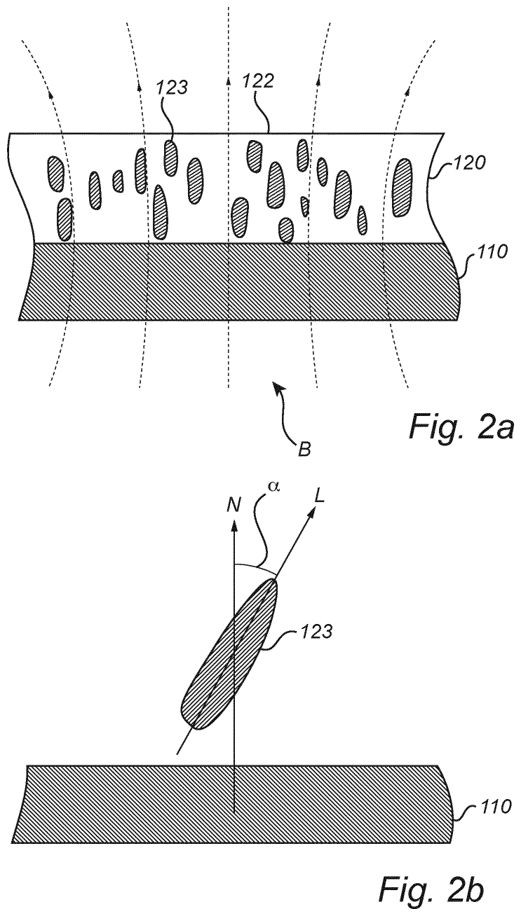

During the coating process, the carbonaceous particles 122 of the active layer 120 may be exposed to a magnetic field B oriented along a normal N to the surface of the substrate 110. An example of such a particle aligning process, in which a majority of the carbonaceous particles may be ordered in relation to the orientation of the surface of the substrate 110, is shown in FIGS. 2a and b. In FIG. 2a is shown how the field lines of the magnetic field B are oriented to pass through the active layer 120 in a direction substantially parallel to the normal N of the substrate 110. Due to the magnetic properties of the particles 122, which may be diamagnetic, paramagnetic of ferromagnetic, at least some of the particles may be oriented along the field lines of the magnetic field B. Preferably, a majority of the particles 122 of the active layer 120 may be oriented substantially parallel to the normal N of the substrate 110.

FIG. 2b illustrates the orientation of a particle 122 in relation to the normal N of the substrate 110. The particle 122, which may be an elongated particle or a flake-shaped particle, is oriented such that its length direction L or main plane of extension (e.g., in case of a flake) is substantially parallel to the normal N. As indicated in the figure, the orientation may deviate slightly from the normal N, forming an angle a with the normal N. The angle a may lie in the interval of 0° to 45° for particles 122 being substantially parallel to the normal N. Particles with angles a exceeding 45° may be considered as aligned with the surface of the substrate, i.e., substantially orthogonal to the normal N.

The particles 122 may comprise graphite, such as graphite flakes, which is known to be a diamagnetic material. To increase their response to an applied magnetic field, the particles 122 may be doped with paramagnetic of ferromagnetic particles. The dopant may comprise nanoparticles, for instance comprising Fe₃O₄. Fe₃O₄ particles may be attached to the surface of graphite particles by means of van Der Waals forces, and may beneficially turn the graphite particles into paramagnetic particles. The graphite flakes may for example be fine or medium flakes. Fine flakes typically have a D50 particle size in the range of from 1 to 7 μm and medium flakes typically have a D50 particle size in the range of from 8 to 18 μm.

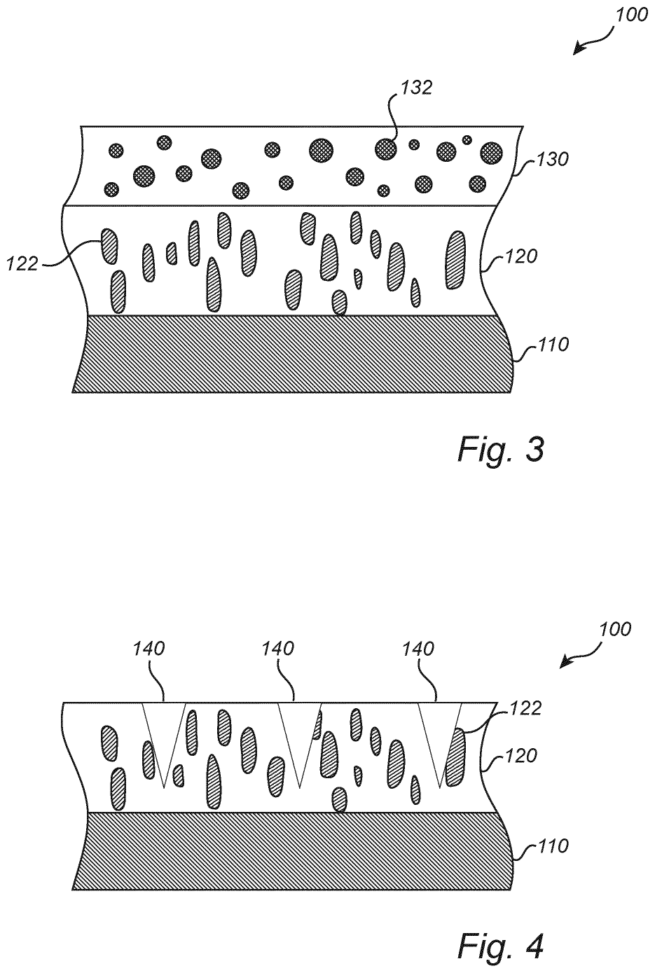

In FIG. 3, a coating layer 130 has been formed on the active layer 120. The coating layer may, similar to the underlying active layer 120, comprise a plurality of coating layer particles 132 such as e.g., graphite particles, silicon-based particles or a combination of both. Examples of silicon-based materials include metallic Si, Si alloys, and SiOx, where x is below or equal to 2. Further, the particles 132 of the coating layer may be oriented along the normal to the substrate 110 in a similar way as described above for the particles 122 of the active layer 120.

The interface between the active layer 120 and the coating layer 130 may not necessarily be identifiable in an electron scanning microscope.

The coating layer 130 may also have been subject to a compacting process, or calendering process, in which the coating layer 130 has been pressed or rolled to increase the density of the coating layer 130.

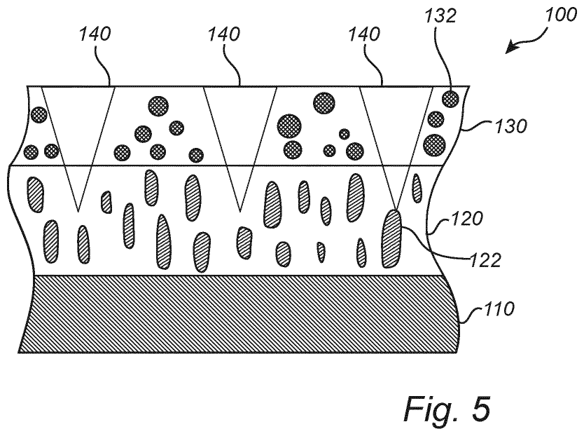

The coating layer 130 may be arranged to protect the underlying active layer 120 from mechanical damage during subsequent processing and reduce the risk of the particles 122 being misaligned. To further improve the electrochemical performance of the coating layer 130 and thus the entire electrode 100, the coating layer may be provided with a plurality of passages facilitating ionic transport towards the substrate 110. An example of such passages will be discussed in the following with reference to FIG. 4 and FIG. 5.

FIG. 4 shows an electrode 100 which may be similarly configured as the electrode 100 shown in FIG. 2a. As indicated in the present figure, a plurality of passages 140 may be arranged in the active layer 120. The passages 140 may be formed by means of a pulsed laser beam or mechanical rolling, and may extend substantially parallel to the normal N of the substrate and at least halfway down to the substrate 110. In some examples, the plurality of passages 140 may have a length corresponding to more than 0% to 95%, such as from 5% to 95%, such as from 25% to 90%, such as from 50% to 90% of the thickness of the active layer 120. Further, the passages 140 may have a diameter of less than 60 μm, such as from 5 to 60 μm, such as from 10 to 50 μm, such as from 10 to 40 μm, such as from 12 to 35 μm, such as from 15 to 35 μm, such as from 15 to 30 μm.

The passages 140 shown in FIG. 4 are conical. It is understood that the passages 140 may have other shapes depending on the focus distance of the laser beam.

FIG. 5 shows an electrode 100 which may be similarly configured as the electrode 100 shown in FIG. 3. However, as indicated in the present figure, a plurality of passages 140 may be arranged in the coating layer 130. The passages 140 may be formed by means of a pulsed laser beam or mechanical rollers, and may extend substantially parallel to the normal N of the substrate and extend at least partly into the active layer 120. In some examples, passages extend into the active layer 120 at a depth of from 0% to 95%, such as from 5% to 95%, such as from 25% to 90%, such as from 50% to 90% of the thickness of the active layer 120 of the thickness of the active layer 120. Further, the passages may have a diameter of less than 60 μm, such as from 5 to 60 μm, such as from 10 to 50 μm, such as from 10 to 40 μm, such as from 12 to 35 μm, such as from 15 to 35 μm, such as from 15 to 30 μm.

Furthermore, although specific terms may be employed herein, they are used in a generic and descriptive sense only and not for purposes of limitation. Therefore, persons skilled in the art would recognize numerous variations to the described examples that would still fall within the scope of the appended claims. As used herein, the terms “comprise/comprises” or “include/includes” do not exclude the presence of other elements of steps. Furthermore, although individual features may be included in different claims (or examples) these may possibly advantageously be combined, and the inclusion of different claims (or example) does not imply that a certain combination of features is not feasible and/or advantageous. In addition, singular references do not exclude a plurality. Finally, reference numerals in the claims are provided merely as a clarifying example and should not be construed as limiting the scope of the claims.

### ITEMIZED LIST OF EMBODIMENTS

1. A method for manufacturing an electrode (100) for a secondary cell, comprising the steps of:
   providing an electrode substrate (110) comprising an electrically conducting material;
   forming an active layer (120) on the electrode substrate, wherein the active layer comprises a plurality of carbonaceous particles (122);
   exposing the active layer to a magnetic field (B) configured to orient a majority of the particles along a normal (N) of the substrate; and exposing the active layer to laser pulses or mechanical rollers to form a
   plurality of passages (140) in the active layer, thereby facilitating ionic transport towards the substrate.
2. The method according to item 1, wherein the plurality of carbonaceous particles are graphite particles.
3. The method according to item 1 or 2, further comprising adding a dopant to the plurality of carbonaceous particles.
4. The method according to any of the preceding items, further comprising:
   forming a coating layer (130) on the active layer, and
   forming the plurality of passages to extend through the coating layer.
5. The method according to item 4, wherein the coating layer comprises a plurality of coating layer particles.
6. The method according to item 5, further comprising exposing the coating layer to a magnetic field configured to orient a majority of the coating layer particles along the normal of the substrate.
7. The method according to any one of the preceding items, wherein the plurality of passages extend substantially parallel to the normal of the substrate.
8. The method according to any of the preceding items, wherein the plurality of passages extend at least halfway through the active layer.
9. The method according to any of the preceding items, further comprising:
   calendering the active layer and the substrate to increase a coating density of the electrode.
10. An electrode (100) for a secondary cell, comprising:
   an electrode substrate (110) comprising an electrically conducting material; and
   an active layer (120) arranged on the substrate;
   wherein the active layer comprises a plurality of passages (140) extending in a direction substantially parallel to a normal of the substrate to facilitate ionic transport towards the substrate; and
   wherein the active layer comprises a plurality of carbonaceous particles (122), of which a majority are oriented substantially parallel to the normal (B) of the substrate.
11. The electrode according to item 10, wherein the carbonaceous particles comprise graphite.
12. The electrode according to item 10 or 11, wherein the carbonaceous particles are doped with a dopant.
13. The electrode according to any of items 10-12, having an electrode density of 1.4 to 1.7 g/cm³.
14. The electrode according to any one of items 10-13, further comprising a coating layer (130) formed on the active layer, wherein the plurality of passages are arranged at least in the coating layer to facilitate ionic transport towards the substrate.
15. The electrode according to item 14, wherein the coating layer comprises a plurality of coating layer particles (132).
16. The electrode according to item 15, wherein the coating layer particles comprise graphite or a silicon-based material.
17. The electrode according to item 15 or 16, wherein a majority of the coating layer particles are oriented along the normal of the substrate.
18. The electrode according to any of items 14-17, wherein the active layer has a thickness of from 10 to 120 μm and wherein the coating layer has a thickness of from 10 to 120 μm.
19. A secondary cell comprising an electrode (100) according to any one of items 10-18.

1. A method for manufacturing an electrode (100) for a secondary cell, comprising the steps of:
providing an electrode substrate (110) comprising an electrically conducting material;
forming an active layer (120) on the electrode substrate, wherein the active layer comprises a plurality of carbonaceous particles (122);
exposing the active layer to a magnetic field (B) configured to orient a majority of the particles along a normal (N) of the substrate; and
exposing the active layer to laser pulses or mechanical rollers to form a plurality of passages (140) in the active layer, thereby facilitating ionic transport towards the substrate.

2. The method according to claim 1, wherein the plurality of carbonaceous particles are graphite particles.

3. The method according to claim 1, further comprising adding a dopant to the plurality of carbonaceous particles.

4. The method according to claim 1, further comprising:
forming a coating layer (130) on the active layer, and
forming the plurality of passages to extend through the coating layer.

5. The method according to claim 4, wherein the coating layer comprises a plurality of coating layer particles.

6. The method according to claim 5, further comprising exposing the coating layer to a magnetic field configured to orient a majority of the coating layer particles along the normal of the substrate.

7. The method according to claim 1, wherein the plurality of passages extend substantially parallel to the normal of the substrate.

8. The method according to claim 1, wherein the plurality of passages extend at least halfway through the active layer.

9. The method according to claim 1, further comprising:
calendering the active layer and the substrate to increase a coating density of the electrode.

10. An electrode (100) for a secondary cell, comprising:
an electrode substrate (110) comprising an electrically conducting material; and
an active layer (120) arranged on the substrate;
wherein the active layer comprises a plurality of passages (140) extending in a direction substantially parallel to a normal of the substrate to facilitate ionic transport towards the substrate; and
wherein the active layer comprises a plurality of carbonaceous particles (122), of which a majority are oriented substantially parallel to the normal (B) of the substrate.

11. The electrode according to claim 10, wherein the carbonaceous particles comprise graphite.

12. The electrode according to claim 10, wherein the carbonaceous particles are doped with a dopant.

13. The electrode according to claim 10, having an electrode density of 1.4 to 1.7 g/cm³.

14. The electrode according to claim 10, further comprising a coating layer (130) formed on the active layer, wherein the plurality of passages are arranged at least in the coating layer to facilitate ionic transport towards the substrate.

15. The electrode according to claim 14, wherein the coating layer comprises a plurality of coating layer particles (132).

16. The electrode according to claim 15, wherein the coating layer particles comprise graphite or a silicon-based material.

17. The electrode according to claim 15, wherein a majority of the coating layer particles are oriented along the normal of the substrate.

18. The electrode according to claim 14, wherein the active layer has a thickness of from 10 to 120 μm and wherein the coating layer has a thickness of from 10 to 120 μm.

19. A secondary cell comprising an electrode (100) according to claim 10.
